(19) United States
(12) Patent Application Publication
(10) Pub. No.: US 2024/0244484 A1
(43) Pub. Date: Jul. 18, 2024

(54) METHODS AND APPARATUSES FOR CONTROLLING LOAD REPORTING

(71) Applicant: Telefonaktiebolaget LM Ericsson (publ), Stockholm (SE)

(72) Inventors: Luca Lunardi, Genoa (IT); Angelo Centonza, Granada (ES); Pablo Soldati, Solna (SE)

(21) Appl. No.: 18/290,779

(22) PCT Filed: Jul. 30, 2022
(86) PCT No.: PCT/EP2022/071486

§ 371 Date: Jan. 21, 2024

Related U.S. Application Data
(60) Provisional application No. 63/227,382, filed on Jul. 30, 2021.

(51) Int. Cl. H04W 28/086; H04W 24/10

(52) U.S. Cl. CPC H04W 28/0861; H04W 24/10

(57) ABSTRACT

A method is disclosed that is performed by a first network node in communication with a second network node. The second network node has been requested or is being requested to send measurements and/or predictions available at the second network node to the first network node. The method comprises receiving, from the second network node, a first message comprising a first indication that sending of measurements and/or predictions from the second network node to the first network node is to be paused, delayed, resumed, or stopped. Also disclosed are a method performed by a second network node, and first and second network nodes.

### TECHNICAL FIELD

The present disclosure relates to methods performed by first and second network nodes that are in communication, wherein the second network node has been requested or is being requested to send measurements and/or predictions available at the second network node to the first network node. The present disclosure also relates to first and second network nodes a computer program and a computer program product configured, when run on a computer to carry out such methods.

### BACKGROUND

### 5G RAN Architecture

The overall architecture of Next Generation Radio Access Network (NG-RAN) is described in 3GPP TS 38.401 v16.6.0 (2021-06), FIG. 1 illustrates an example of a NG-RAN architecture.

The NG-RAN consists of a set of base stations (e.g. gNBs) connected to the 5G Core (5GC) through the NG interface.

As specified in TS 38.300 V16.6.0 (2021 Jul. 6), NG-RAN may also comprise a set of next generation eNBs (ng-eNBs), an ng-eNB may comprise an ng-eNB control unit (CU) (ng-eNB-CU) and one or more ng-eNB distributed units (DU(s) (ng-eNB-DU). An ng-eNB-CU and an ng-eNB-DU is connected via W1 interface. The general principle described in this section also applies to ng-eNB and W1 interface, if not explicitly specified otherwise.

gNBs can be interconnected through the Xn interface.

A gNB may comprise of a gNB-CU and one or more gNB-DU(s). A gNB-CU and a gNB-DU may be connected via F1 interface.

One gNB-DU may be connected to only one gNB-CU.

NG, Xn and F1 are logical interfaces.

For NG-RAN, the NG and Xn-C interfaces, for a gNB consisting of a gNB-CU and gNB-DUs, terminate in the gNB-CU. For E-UTRA NR Dual connectivity (EN-DC), the S1-U and X2-C interfaces, for a gNB consisting of a gNB-CU and gNB-DUs, terminate in the gNB-CU. The gNB-CU and connected gNB-DUs may only be visible to other gNBs and the 5GC as a gNB.

The overall architecture for separation of gNB-CU-CP and gNB-CU-UP is depicted in FIG. 2 (taken from TS 38.401 v16.6.0).

As illustrated in FIG. 2, a gNB may consist of a gNB-CU control plane (CP), multiple gNB-CU user planes (Ups) and multiple gNB distributed units (DUs);

The gNB-CU-CP is connected to the gNB-DU through the F1-C interface;

The gNB-CU-UP is connected to the gNB-DU through the F1-U interface;

The gNB-CU-UP is connected to the gNB-CU-CP through the E1 interface;

One gNB-DU may be connected to only one gNB-CU-CP;

One gNB-CU-UP may be connected to only one gNB-CU-CP;

One gNB-DU can be connected to multiple gNB-CU-UPs under the control of the same gNB-CU-CP;

One gNB-CU-UP can be connected to multiple DUs under the control of the same gNB-CU-CP.

The overall architecture of Integrated Access and Backhaul (IAB) is depicted in FIG. 3 (taken from TS 38.401 v16.6.0).

The NG-RAN supports IAB by the IAB-node wirelessly connecting to the gNB capable of serving the IAB-nodes, which may be referred to as an IAB-donor.

The IAB-donor comprises an IAB-donor-CU and one or more IAB-donor-DU(s). In case of separation of gNB-CU-CP and gNB-CU-UP, the IAB-donor may comprise an IAB-donor-CU-CP, multiple IAB-donor-CU-UPs and multiple IAB-donor-DUs.

The IAB-node may connect to an upstream IAB-node or an IAB-donor-DU via a subset of the user equipment (UE) functionalities of the New Radio (NR) Uu interface (named IAB Mobile Termination (IAB-MT) function of IAB-node). The IAB-node provides wireless backhaul to the downstream IAB-nodes and UEs via the network functionalities of the NR Uu interface (named IAB-DU function of IAB-node).

The F1-C traffic between an IAB-node and IAB-donor-CU is backhauled via the IAB-donor-DU and the optional intermediate hop IAB-node(s).

The F1-U traffic between an IAB-node and IAB-donor-CU is backhauled via the IAB-donor-DU and the optional intermediate hop IAB-node(s).

### Multi-Connectivity Architecture Overview

Architectural overviews for multi-connectivity are depicted in 3GPP TS 37.340 v16.5.0 (2021-03).

For example, EN-DC overall architecture is illustrated in FIG. 4 (taken from 3GPP TS 37.340 v16.5.0).

### Load Balancing Overview

For different radio access networks, such as EUTRAN, NG-RAN, including Multi-Radio Dual Connectivity options, standard procedures exist to assist a network node to determine load balancing actions.

For example, the following procedures are defined in 3GPP TS 36.423 v16.6.0 (2021-06):

Resource Status Reporting Initiation (clause 8.3.6);

Resource Status Reporting (clause 8.3.7);

EN-DC Resource Status Reporting Initiation (clause 8.7.21); and

EN-DC Resource Status Reporting (clause 8.7.22).

The following procedures are defined in 3GPP TS 38.423 v16.6.0 (2021-06):

Resource Status Reporting Initiation (clause 8.4.10); and

Resource Status Reporting (clause 8.4.11)

A common pattern is used across all the procedures listed above, e.g. used for requesting and reporting load related metrics. In particular, all the procedures listed above utilize the following pattern:

A first network node requests a second network node to start or stop sending load metrics. The request can indicate if the second network node should send to the first network node load metrics as one-time reporting or according to a reporting period.

The second network node responds to the first network node by acknowledging the request or indicating a failure.

In case the second network node acknowledges the request, the second network node sends to the first network node load metrics as one-time reporting or periodically according to the received indications.

FIG. 5 illustrates an example of the pattern described above. In particular, FIG. 5 illustrates signaling aspects related to the resource status reporting procedure for E-UTRAN and NG-RAN.

The message used to report load metrics (e.g. measurements and/or predictions of load metrics) may be generically identified as “Resource Status Update”. It will be appreciated that different specifications may assume slightly different names for similar messages.

For example:
the message comprising load metric(s) sent from one eNB to another eNB is referred to as the X2AP RESOURCE STATUS UPDATE message;
the message comprising load metric(s) sent from one NG-RAN node to another NG-RAN node is referred to as the XnAP RESOURCE STATUS UPDATE message
the message comprising load metric(s) sent between one en-gNB and one eNB is referred to as the X2AP EN-DC RESOURCE STATUS UPDATE message.

Some differences exist between E-UTRAN and NG-RAN specifications that are relevant for the present disclosure. In particular, in E-UTRAN an IE exists called Cell Reporting Indicator, that may be optionally present in the X2AP RESOURCE STATUS UPDATE message. The procedural text associated to this IE is reported below (ref. 3GPP TS 36.423 v16.6.0, clause 8.3.7.2):

“If the eNB₁ receives the RESOURCE STATUS UPDATE message, which includes the Cell Reporting Indicator IE set to “stop request” in one or more items of the Cell Measurement Result IE, the eNB₁ should initialise the Resource Status Reporting Initiation procedure to remove all or some of the corresponding cells from the measurement”.

For NG-RAN there is no equivalent IE corresponding to Cell Reporting Indicator IE of E-UTRAN.

In addition to the above, to assist inter-system load balancing decisions, a first network node of a radio access network comprised in a second wireless communication system can request and obtain load metrics from a second network node of a radio access network comprised in a first wireless communication system. As an example, an eNB, connected to EPC, can request and obtain load metric from a gNB, connected to 5GC.

To support the mentioned use case, procedures are being specified as part of standardization work done by 3GPP RAN3 WG, see Work Item on “Enhancement of Data Collection for SON/MDT in NR”.

There currently exist certain challenge(s).

These challenges are discussed below in the context of the current 3GPP standard for E-UTRAN, but this should not be regarded as a limiting scenario.

In E-UTRAN, after a first network node has requested a second network node to report load measurements (e.g., by means of a RESOURCE STATUS REQUEST message), it is possible for the second network node to request that load measurement reports are stopped by means of a RESOURCE STATUS UPDATE message, which includes the Cell Reporting Indicator IE set to “stop request” in one or more items of the Cell Measurement Result IE. In response to this request, the first network node should initialize the Resource Status Reporting Initiation procedure to remove all or some of the corresponding cells from the measurement.

When the first network node receives from the second network node an indication to stop the reporting of load measurements, the first network node is not aware of the reason for the request to stop. Namely, the second network node might have a temporary issue that might be solved shortly after the “stop request” or it might have an issue persisting for a longer time.

If the first network node is interested to resume the load measurements, the first network node has to send a new request to the second network node, potentially a number of times until the second network node is able to reply positively to the request. This has a detrimental effect on the signaling load between the first network node and the second network node.

Furthermore, if the first network node and the second network node are comprised in different wireless communication systems, there is an additional negative effect in the excess signaling traversing one or more third network nodes acting as intermediate nodes forwarding the messages between the first network node and the second network node (e.g. the third network nodes may be Core Network nodes).

### SUMMARY

Certain aspects of the disclosure and their embodiments may provide solutions to the above noted or other challenges.

According to a first aspect of the present disclosure, in a communication network comprising a first network node and a second network node, the second network node may be configured to have sent, be sending, or be about to send to the first network node measurements and/or predictions available at the second network node. The measurements and/or predictions may relate to load metrics.

The first network node receives from the second network node a first message comprising:
a first indication related to the sending of measurements and/or predictions from the second network node to the first network node. The first indication may comprise an indication that sending of measurements and/or predictions from the second network node to the first network node is to be paused, delayed, resumed, or stopped.

The first message may further comprise a start time at which the first indication applies. For example the start time may indicate from when the sending of the measurements and/or predictions is/will be stopped/paused/resumed/delayed

The first message may further comprise a stop time at which the first indication applies. For example, the stop time may indicate a time until which the sending of the measurements and/or predictions is/will be stopped/paused/resumed/delayed The first message may comprise both a start time to an end time.

The first message may comprise a duration for which the first indication will apply. For example, the duration may comprise a paused reporting time during which sending is/will be paused. For example, the duration may comprise a delayed reporting time during which sending is/will be delayed. The first message may also comprise a resumed reporting time from which sending is/will be resumed.

The first message may comprise a second reporting periodicity (e.g. a reporting periodicity other than a first reporting periodicity used by the second network node to send measurements and/or predictions before the sending is modified).

The first message may further comprise a reason for pausing, delaying, resuming or stopping the sending of measurements and/or predictions from the second network node to the first network node. The reason may comprise a cause value.

The first message may further comprise an indication, indicating that the reason causing the modification in the sending is resolved, and that the sending will continue according to a first configuration agreed between the first network node and the second network node.

The first message may comprise second indication of one or more measurements and/or predictions to which the first indication applies.

The first message may further comprise a third indication of one or more reporting objects associated with one or more measurements and/or predictions to which the first indication applies.

In some embodiments, the first message may be the same message used by the second network node to send measurements and/or predictions to the first network node or a different message. In some embodiments the first message may comprise a separate message to the message used by the second network node to send measurements and/or predictions to the first network node or a different message.

In non-limiting examples of implementation, the first message may be implemented as an XnAP RESOURCE STATUS UPDATE message, an X2AP RESOURCE STATUS UPDATE message, an X2AP EN-DC RESOURCE STATUS UPDATE message, an F1AP RESOURCE STATUS UPDATE message, an E1AP RESOURCE STATUS UPDATE message.

Examples of the embodiments described herein provide the possibility to adjust an ongoing process during which a first network node receives from a second network node reporting of measurements and/or predictions. The main adjustment relates to the possibility for the first network node to receive from the second network node indications of pauses and or resumptions in sending measurements and/or predictions (e.g. as previously requested by the first network node). The first network node may also receive an indication (e.g. a cause value) indicating the reason for the action taken by the second network node.

Certain embodiments may provide one or more of the following technical advantage(s).

An advantage of the proposed solution is to overcome some limitations of current solutions for reporting load metrics between RAN nodes.

In 5G systems, a RAN node may be requested to report a large number of measurements, predictions and various other statistics. The RAN node may not be able to report all the measurements and/or predictions configured by other RAN nodes in the system, and it might need to reduce the reporting of said measurements and/or predictions. Such a reduction may be due to, for example, transport resource limitations or internal processing limitations. An advantage of the embodiments described herein is allowing a first network node (e.g. RAN node) to become aware of the fact that some or all the measurements expected to be reported by a second network node (e.g. RAN node), may not be reported for some time in the future.

Thanks to this, the first network node may avoid sending repeated requests towards the second network node to reinitiate the measurement reports, and may instead wait for further notification from the second network node confirming that the issue preventing measurements reporting has been solved, or wait until such measurement reports are resumed by the second network node.

If the first and second network nodes are comprised within different wireless communication systems (i.e. they are connected to different Core Networks), it may be possible to avoid excess signaling traversing one or more third network nodes (e.g. the third network nodes can be Core Network nodes) acting as intermediate nodes to forward the messages between the first network node and the second network node.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an example of a NG-RAN architecture.

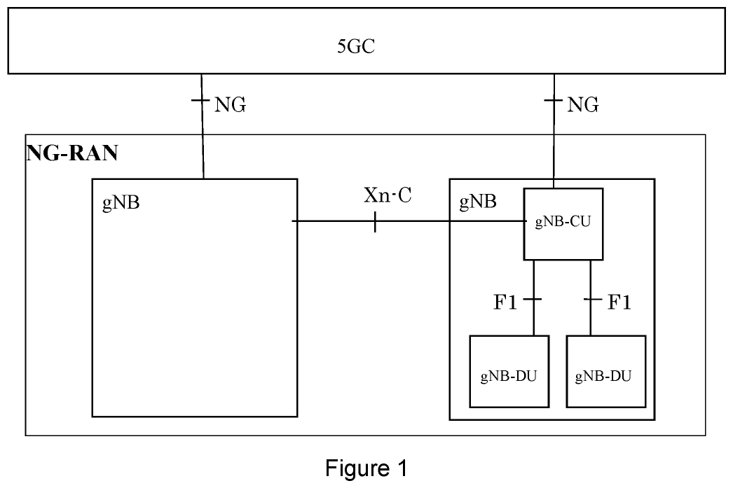

FIG. 2 illustrates the overall architecture for separation of gNB-CU-CP and gNB-CU-UP;

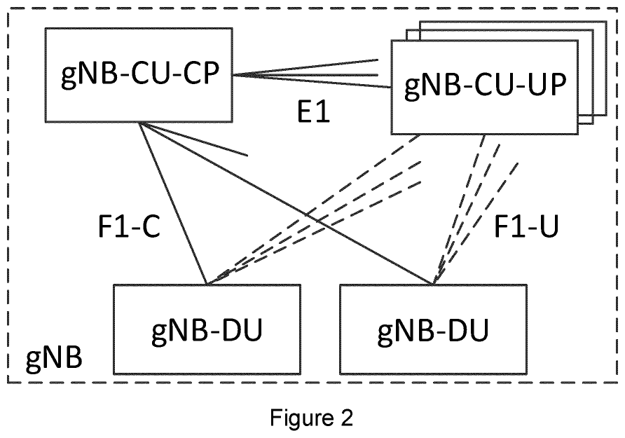

FIG. 3 illustrates the overall architecture of Integrated Access and Backhaul;

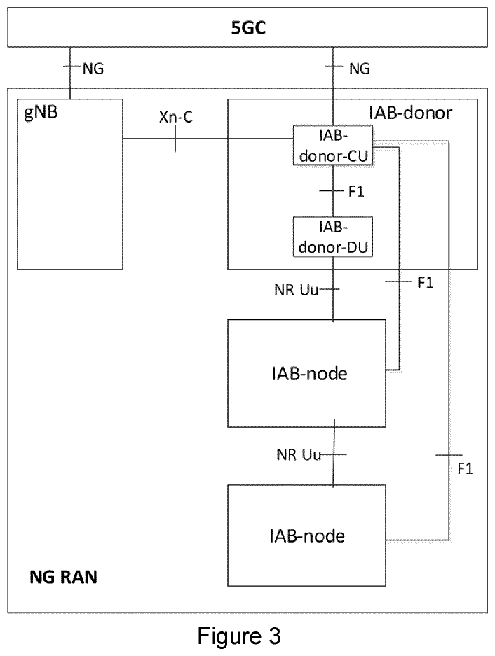

FIG. 4 illustrates the EN-DC overall architecture;

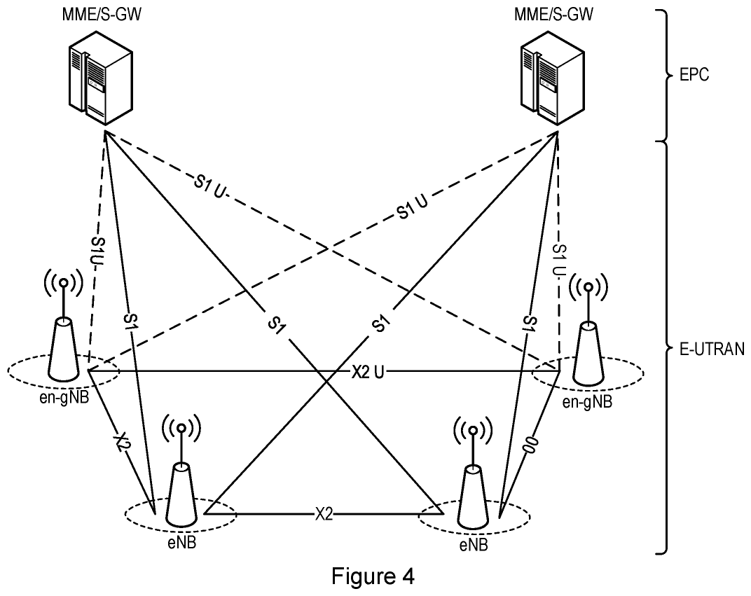

FIG. 5 illustrates signaling aspects related to the resource status reporting procedure for E-UTRAN and NG-RAN;

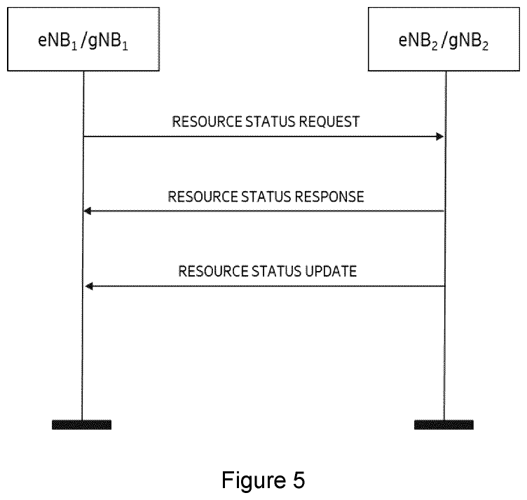

FIG. 6 illustrates a method in accordance with some embodiments;

FIG. 7 illustrates a method in accordance with some embodiments;

FIG. 8 is a signaling diagram illustrating an example implementation of the methods of FIGS. 6 and 7;

FIG. 9 illustrates an example of Paused/Resumed/Delayed measurements and/or predictions;

FIG. 10 illustrates a method wherein the first network node transmits a second message to the second network node in response to receiving the first message from the second network node;

FIG. 11 illustrates a method wherein the second network node receives a third message from the first network node prior to transmitting the first message to the first network node;

FIG. 12 illustrates a method wherein the second network node further transmits a fourth message to the first network node responsive to the third message to acknowledge or to refuse at least one of the requests comprised in the third message;

FIG. 13 shows an example of a communication system 1300 in accordance with some embodiments;

FIG. 14 shows a UE 1400 in accordance with some embodiments;

FIG. 15 shows a network node 1500 in accordance with some embodiments;

FIG. 16 is a block diagram of a host 1600, which may be an embodiment of the host 1316 of FIG. 13, in accordance with various aspects described herein;

FIG. 17 is a block diagram illustrating a virtualization environment 1700 in which functions implemented by some embodiments may be virtualized;

FIG. 18 shows a communication diagram of a host 1802 communicating via a network node 1804 with a UE 1806 over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

For the embodiments described herein, the following is considered:
a network node may comprise a RAN node, a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, Open RAN (O-RAN) Central Unit (O-CU), O-RAN Central Unit-Control Plane (O-CU-CP), O-RAN Central Unit-User Plane (O-CU-UP), O-RAN Distributed Unit (O-DU), O-RAN Radio Unit (O-RU), O-RAN eNB (O-eNB).

The embodiments described herein disclose signaling aspects exchanged between a first network node and a second network node of a communication network.

The first network node and the second node may each comprise one of: a RAN node, a gNB, eNB, en-gNB, ng-eNB, gNB-CU, gNB-CU-CP, gNB-CU-UP, gNB-DU, eNB-CU, eNB-CU-CP, eNB-CU-UP, eNB-DU, IAB-nodes, IAB-donors, IAB-donor-CU, IAB-donor-CU-CP, IAB-donor-CU-UP, IAB-donor-DU, IAB-MT, O-CU, O-CU-CP, O-CU-UP, O-DU, O-RU, O-eNB.

The embodiments described herein may be applicable in cases of different connectivity between the first network node and the second network node. Non-limiting examples are:
the first network node and the second network node are both comprised within the same communication system. For example, the first network node and the second network node may be connected to the same Core Network (e.g. both to EPC or both to 5GC)
the first network node and the second network node are comprised within different communication system. For example, the first network node and the second network node may be connected to different Core Networks (e.g. the first network node is connected to EPC and the second network node is connected to 5GC or vice versa)
a direct signaling connection may exist between the first network node and the second network node (e.g. via XnAP, X2AP, F1AP, E1AP, W1AP)
an indirect signaling connection may exist between the first network node and the second network node (e.g. comprising NGAP and/or S1AP and/or CN signaling protocols)
an indirect signalling connection may comprise signaling between the first network node and the second network node (in both directions) being conveyed via one or more third network nodes, wherein a third network node may comprise be a RAN node, a CN node, an OAM node or an SMO node. A third network node may forward the signaling between the first network and the second network node and may not interpret it. A third network node may alternatively interpret the signaling between the first network node and the second network node.
the first network node and the second network node may comprise two functions of a RAN node in a distributed architecture. For example, the first network node and the second network node may each comprise one of: gNB-DU, a gNB-CU-CP, a gNB-CU-UP, eNB-DU, eNB-CU-CP, and eNB-CU-UP within the same gNB. The signaling connection between the first network node and the second network node may be realized e.g. as one of an E1AP, F1AP, or W1AP interface.

In one example of an indirect signalling connection, the first network node may comprise a gNB, the second network node may comprise an eNB, the indirect signalling connection between the first and second nodes may be established via two core network nodes in between, one AMF connected to the gNB, and one MME connected to the eNB. The indirect signalling connection then comprises the connections from gNB to AMF to MME to eNB, and from eNB to MME to AMF to gNB.

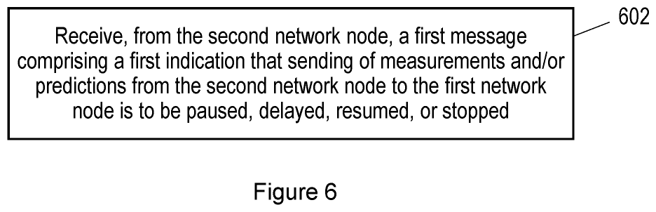

FIG. 6 illustrates a method in accordance with some embodiments.

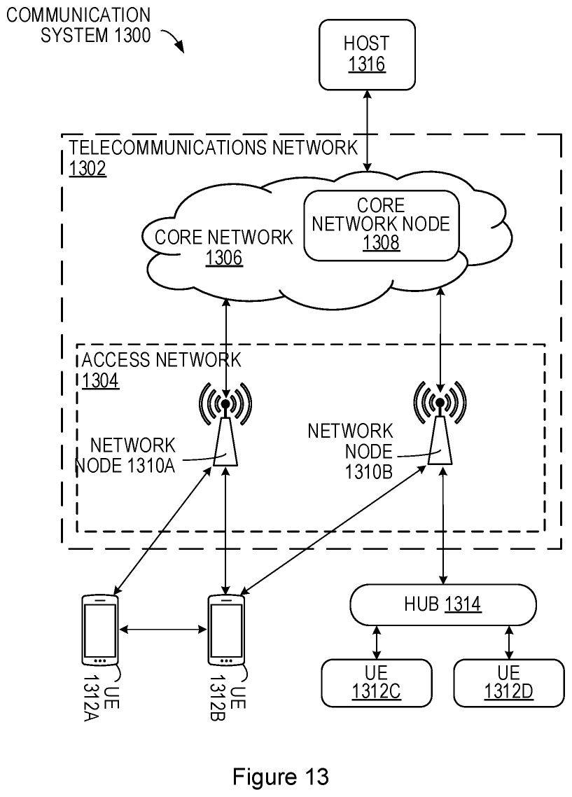

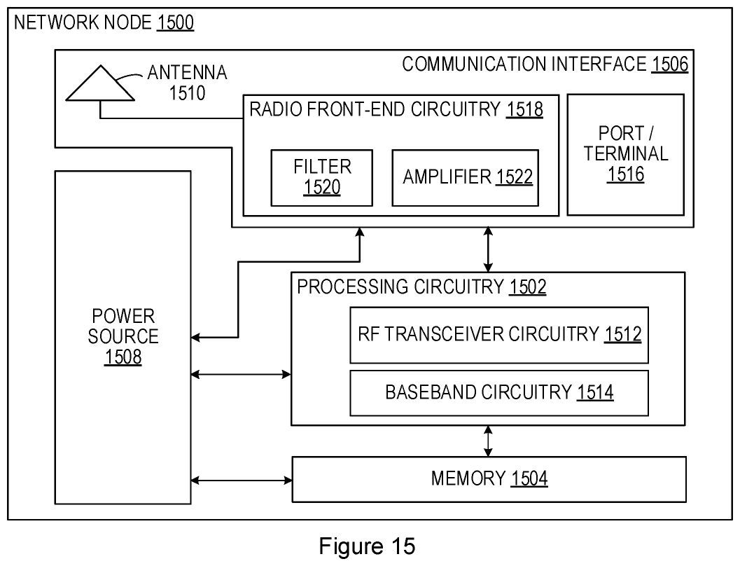

The method of FIG. 6 may be performed by a first network node (e.g. the network node 1310 or network node 1500 as described later with reference to FIGS. 13 and 15 respectively). The first network node may be in communication with a second network node, (e.g. the network node 1310- or network node 1500 as described later with reference to FIGS. 13 and 15 respectively). The second network node has been requested or is being requested to send measurements and/or predictions available at the second network node to the first network node. The method begins at step 602 with receiving, from the second network node, a first message comprising a first indication that sending of measurements and/or predictions from the second network node to the first network node is to be paused, delayed, resumed, or stopped.

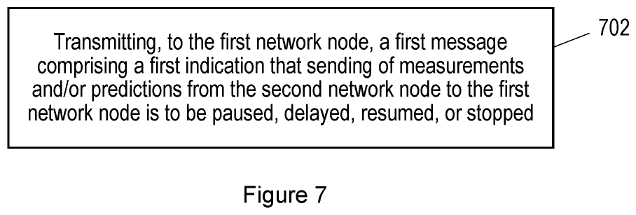

FIG. 7 illustrates a method in accordance with some embodiments.

The method 7 may be performed by a second network node (e.g. the network node 1310 or network node 1500 as described later with reference to FIGS. 13 and 15 respectively). The second network node may be in communication with a first network node, (e.g. the network node 1310- or network node 1500 as described later with reference to FIGS. 13 and 15 respectively). The second network node has been requested or is being requested to send measurements and/or predictions available at the second network node to the first network node. The method begins at step 702 with transmitting, to the first network node, a first message comprising a first indication that sending of measurements and/or predictions from the second network node to the first network node is to be paused, delayed, resumed, or stopped.

The first indication may be seen as indicating a modification related to the sending of measurements and/or predictions from the second network node to the first network node. It will be appreciated that the first message may comprise a plurality of indications, each indicating a different modification.

It will also be appreciated that the measurements and/or predictions measurements and/or predictions available at the second network node may comprise measurements and/or predictions of the second network node and/or measurements and/or predictions of a third network node, the third network node being a RAN node or one of the functions of a RAN node if a RAN node in distributed architecture.

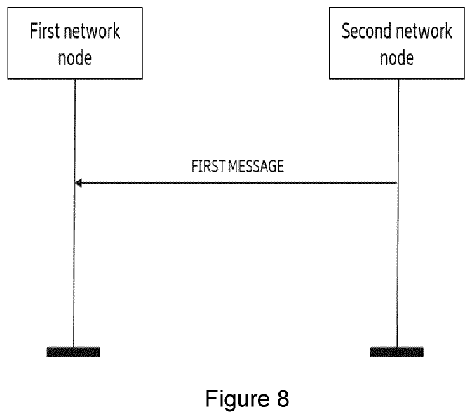

FIG. 8 is a signalling diagram illustrating an example implementation of the methods of FIGS. 6 and 7. The first network node receives a first message from a second network node. The first message may comprise a one or more indication requesting or indicating one or more modifications related to the sending of measurements and/or predictions from the second network node to the first network node. In one embodiment, the first message comprises a first indication that sending of measurements and/or predictions from the second network node to the first network node is to be paused, delayed, resumed, or stopped. The sending of the first message from the second network node to the first network node may correspond to steps 602 and 702 as described with reference to FIG. 7.

The first message may further indicate whether the sending of measurements and/or predictions from the second network node to the first network node, will be/is forecasted to be paused, resumed, delayed or stopped or if the sending of measurements and/or predictions from the second network node to the first network node is paused, resumed, delayed or stopped with immediate effect.

For example, the first message may comprise a start time of modified reporting starting from which, sending of measurements and/or predictions from the second network node to the first network node is/will be stopped, or paused, or resumed, or delayed, or is forecasted to be stopped/paused/resumed/delayed. For example, the first message may comprise a start time at which the first indication applies.

Such a start time may be expressed in various formats. Non-limiting examples can be one or a combination of: a number of reporting periods, the start of a timer, the expiration of timer, the reset of a timer, a number of seconds, a number of sampling occasions, a number of SFN(s), time from an epoch, relative to the reception or transmission of a message, relative to the reception/transmission of an indication, relative to an event (e.g. a radio related event), relative to the initiation or the completion of a procedure (e.g. at initiation of a Resource Status Update, at initiation of a network node configuration update, at start of a handover preparation/execution, of a Conditional handover, of a Dual Active Protocol Stack (DAPS) handover, an Secondary Cell Addition/Removal, a Primary Cell or Secondary Cell Change), relative to a change in the configuration of at least one of the reporting object (e.g. a network node (e.g. a complete gNB or a function of the gNB, such as a gNB-DU or a gNB-CU-CP), one or more Cells, one or more Synchronization Signal/PBCH block (SSB) Index, one or more SSB Area, one or more Single Network Slice Selection Assistance informations (S-NSSAIs) or Slice (e.g. at least one S-NSSAI), one or more Channel State Information Reference Signal (CSI-RS) coverage areas, one or more Tracking Area/Tracking Area List/Public Land Mobile Networks (PLMNs)).

In some examples, a special setting may be used to indicate start time of modified reporting. For example, a feature with no value or a value equal to 0 may be used to indicate a modification of the sending with immediate effect.

For example, the first message may comprise an end time of modified reporting, until which the sending of measurements and/or predictions from the second network node to the first network node is/will be stopped/paused/resumed/delayed or is forecasted to be stopped/paused/resumed/delayed. For example, the first message may comprise an end time at which the first indication will no longer apply.

An end time may be expressed in various formats, similarly to how the start time may be expressed as described above. In some examples, a special setting may be used to indicate an end time of modified reporting. For example, a feature with no value or a value equal to −1 may be used to indicate that sending is modified until further indication(s) is(are) received.

The first message may further comprise a duration for which the first indication will apply. For example, the first message may indicate one or more time intervals of modified reporting, from a start time to an end time, during which the sending of measurements and/or predictions from the second network node to the first network node is/will be stopped/paused/resumed/delayed or is forecasted to be stopped/paused/resumed/delayed. This duration can be expressed in various formats, similarly to a start time and/or an end time.

The duration may comprise a “paused reporting time” during which, sending of measurements and/or predictions from the second network node to the first network node is/will be paused or is forecasted to be paused; a “resumed reporting time” from which, sending of measurements and/or predictions from the second network node to the first network node is/will be resumed or is forecasted to be resumed; or a “delayed reporting time” during which, sending of measurements and/or predictions from the second network node to the first network node is/will be delayed or is forecasted to be delayed

In one example of implementation, a duration can indicate that sending of measurements is paused, stopped, delayed with immediate effect for a number “X” of reporting periods, or will be resumed in “X” reporting periods, where the reporting periodicity is known at both the first network node and the second network node.

To restore a sending with no delay, a missing value for the delay time, or a special value of sending update delay time can be used (e.g. a zero value). Sending with no delay can take effect immediately or from a configured/predetermined instance in the future (e.g. from the next sending)

The first message may further indicate an amount of delay in sending current and/or future measurements and/or predictions. The amount of delay can be expressed in various formats, similarly to a start time and/or an end time as described above.

The first message may further indicate whether measurements and/or predictions comprised in the first message were delayed. The first message may in some examples indicate the corresponding delay(s).

In some examples, the second network node may be previously configured to transmit the measurements and/or predictions at a first reporting periodicity. The first message may then comprise a second reporting periodicity that the second network node is to use. The second reporting periodicity may comprise a longer period than the first reporting periodicity.

In some examples, the first message may further indicate whether or not sending of more measurements and/or predictions will be available in the future for the same measurement process.

In some examples, the first message may further indicate whether measurements and/or predictions sent from the second network node to the first network node in the message is or are the last measurements and/or predictions to be sent, and no more measurements and/or predictions will be available.

In some examples, the first message further comprises at least one reason for stopping, pausing, resuming, or delaying the sending of measurements and/or predictions from the second network node to the first network node. Such a reason may comprise a cause value for stopping, pausing, resuming, or delaying the sending of measurements and/or predictions.

In some examples, the first message may further indicate whether sending of measurements and/or predictions from the second network node to the first network node has changed from possible/allowed to not possible/not allowed/prohibited or vice versa.

In some examples, the first message may further indicate that the reason causing a modification in the sending of measurements and/or predictions from the second network node to the first network node is resolved, and the sending of measurements and/or predictions will continue according to a first configuration agreed between the first network node and the second network node

In some examples, the first message comprises a second indication of one or more measurements and/or predictions to which the first indication applied. Non-limiting examples of such measurements and/or predictions, are at least one or part of one of the following:

Downlink (DL) Guaranteed Bit Rate (GBR) Physical resource Block (PRB) usage, Uplink (UL) GBR PRB usage, DL non-GBR PRB usage, UL non-GBR PRB usage, DL Total PRB usage, UL Total PRB usage, Delay Critical UL/DL/Total GBR PRB usage, DL scheduling Physical Downlink Control Channel (PDCCH) Control Channel Element (CCE) usage, UL scheduling PDCCH CCE usage, Composite Available Capacity Downlink, Composite Available Capacity Uplink, Supplementary Uplink capacity, Composite Available Capacity for Supplementary Uplink, Transport Network Layer (TNL) Capacity Indicator, Number of Active UEs, Radio Resource Control (RRC) Connection, Slice Available Capacity, Almost blank Subframe (ABS) Status, Reference Signal Received Power (RSRP) Measurement Report List, Channel State Information (CSI) Report, load metrics related to UE Contexts, load metrics related to Inactive Users (e.g. mean number of stored Inactive UE Contexts, Max number of stored Inactive UE Context), NR-Unlicensed (NR-U) specific load metrics, Listen Before Talk (LBT) related metrics, Random Access Report(s), 2-step Random Access Control (RACH) metrics, 4-step RACH metrics, Radio Link Failure Report(s), Connection Establishment Failure Report(s), Secondary Cell Group (SCG) Failure Information, SCG Failure Information EUTRA, Mobility History Information, UE History Information, Quality of Experience (QoE) metrics, RAN visible QoE values/scores/metrics, energy saving metrics/scores, energy or power consumption metrics/scores, buffer status, data rate, service rate, data volume, packet delay, packet delay jitter, packet error rate, number of failed packets, service availability, service downtime, at least one of the traffic related measurements and/or predictions, location information, positioning data, sensor information, metrics related to handover/Conditional Handover/DAPS handover, metrics related to synchronization.

In some examples, the first message further comprises information associated with measurements and/or predictions, such as median, average, minimum, maximum, uncertainty (e.g. epistemic uncertainty, aleatoric uncertainty), precision, accuracy, time of validity, and/or standard deviation.

In some examples, the first message further comprises a third indication of one or more reporting objects associated with one or more measurements and/or predictions to which the first indication applies. The one or more reporting objects may comprise one or more of: a network node (e.g. a complete gNB or a function of the gNB, such as a gNB-DU or a gNB-CU-CP), one or more cells, one or more SSB Index, one or more SSB Area, one or more S-NSSAIs or Slice (e.g. at least one S-NSSAI), one or more CSI-RS coverage area, one or more Tracking Area/Tracking Area List/PLMNs.

The first message may further comprise an Interface Instance affected by the first indication.

The first message may in some examples indicate that all measurements and/or all predications to be reported by the second network node are affected by the at least one of the indications related to the sending of measurements from the second network node to the first network node.

The first message may in some examples indicate that all reporting objects are affected by at least one of the indications related to the sending of measurements and predictions from the second network node to the first network node.

In some embodiments, the first message may indicate that some or all of the measurements and/or predictions configured for reporting by the first network node should be stopped by the first network node by means of a procedure aimed at reconfiguring the measurement reporting process. Such a reconfiguration may then comprise stopping some or all of the measurement and/or prediction reporting from the second node. However, the first message may also indicate that the second network node may stop reporting of some or all of the measurements and/or predictions as configured by the first network node, even before the reconfiguration from the first node is carried out.

In some embodiments, the first message may be the same message used by the second network node to send measurements and/or predictions to the first network node or a different message.

In some embodiments, the first message may comprise one of: an XnAP RESOURCE STATUS UPDATE message, an X2AP RESOURCE STATUS UPDATE message, an X2AP EN-DC RESOURCE STATUS UPDATE message, an F1AP RESOURCE STATUS UPDATE message, and an E1AP RESOURCE STATUS UPDATE message. The first message may be signaled via one of the following interfaces: XnAP, X2AP, E1AP, F1AP and W1AP

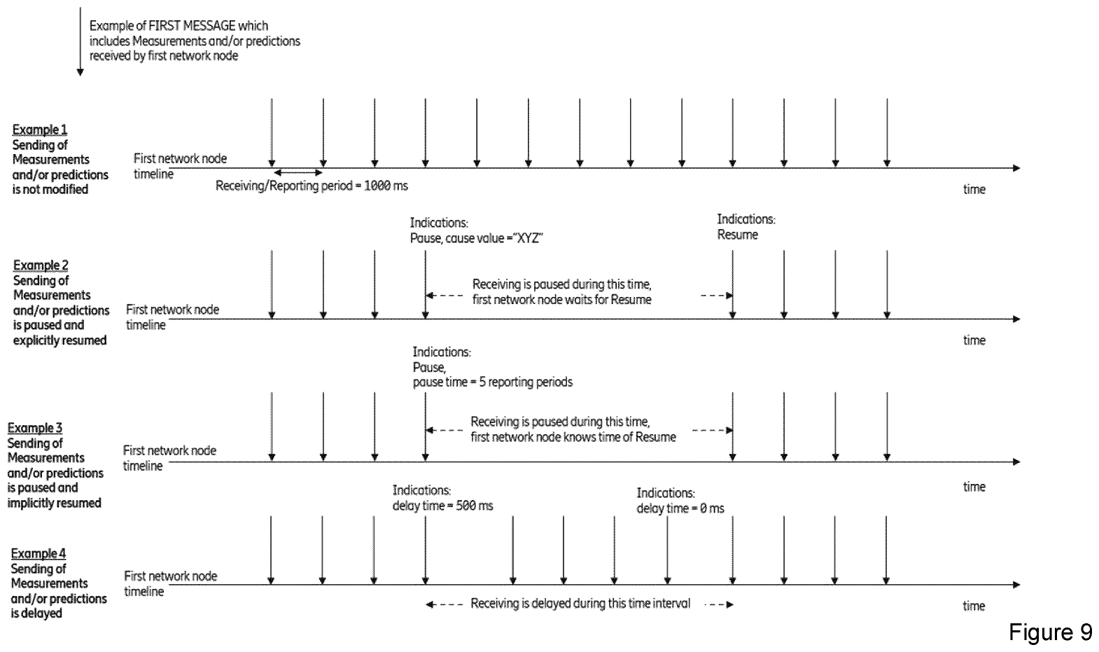

FIG. 9 illustrates an example of Paused/Resumed/Delayed measurements and/or predictions.

In some embodiments, upon reception of the first message, the first network node may perform one or more of the following actions:
waiting for reception of a subsequent first message (e.g. containing an indication that the measurements and/or predictions are resumed or will be resumed);
waiting for reception of subsequent measurements and/or predictions (e.g. after a receiving update pause time or a receiving update resume time);
stopping the reception of measurements and/or predictions from second network node;
determining a third reporting periodicity to use for future requests of measurements and/or predictions from the second network node. The third reporting periodicity may comprise periods that are equal to or longer than the periods of the second reporting periodicity indicated in the first message. For example, the third reporting periodicity may be equal to the second reporting periodicity or a multiple of the second reporting periodicity;
initiating a new request for measurements and/or predictions from second network node. The new request may be for measurements and/or predictions to be provided at the third reporting periodicity (as described above).
accepting, ignoring, discarding or rejecting all received measurements and/or predictions
accepting, ignoring, discarding or rejecting all or part of the received measurements and/or predictions based on conditions.

Non-limiting examples of this may be:
accept or discard “X” of the delayed measurements and/or predictions, where X is an integer value;
ignoring delayed measurements and/or predictions;
accepting only “Y” measurements and/or predictions, where Y is an integer value;
starting or resetting a timer and accepting measurements and/or predictions only if they are received before the timer expires;
accepting/ignoring/discarding or rejecting measurements and/or predictions based on load/overload conditions at the first network node;
accepting or discarding delayed measurements and/or predictions based on the associated delay (e.g. accept only if delay is below a threshold);
accepting or discarding measurements and/or predictions based on information associated with the measurements and/or predictions (e.g. if accuracy is above a threshold);
accepting or discarding measurements and/or predictions based on the concerned reporting object to which measurements and/or predictions are associated;
accepting/ignoring/discarding or rejecting measurements and/or predictions based on ongoing signaling procedures at the first network node (e.g. related to network node configuration update);
accepting/ignoring/discarding or rejecting measurements and/or predictions based on energy savings decisions at the first network node;
using measurements and/or predictions received before sending was modified during the time in which the sending is modified (e.g. whilst sending is paused);
accepting, ignoring, discarding or rejecting for example the first “Z” measurements and/or predictions (where Z is an integer value) received after reception is resumed;
using measurements and/or predictions received before or after reception is modified instead of or in combination with measurements and/or predictions received when reception is modified;
using measurements and/or predictions received during the time of modified reception in the same way (e.g. using a common weight) as measurements and/or predictions received before or after reception is modified;
using measurements and/or predictions received during the time of modified reception in a modified way (e.g. using a different weight) compared to measurements and/or predictions received before or after reception is modified.

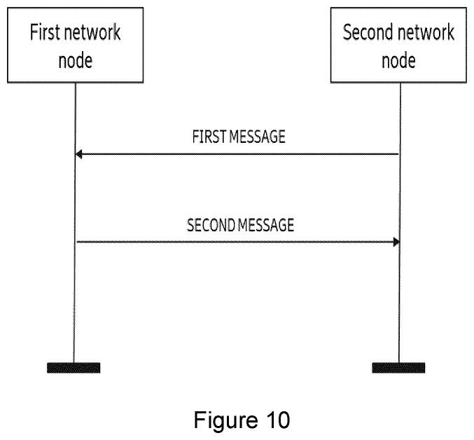

FIG. 10 illustrates a method wherein the first network node transmits a second message to the second network node in response to receiving the first message from the second network node. As previously described, the sending of the first message from the second network node to the first network node may correspond to steps 602 and 702 as described with reference to FIGS. 6 and 7.

In one embodiment illustrated in FIG. 10, responsive to receiving the first message, the first network node may transmit a second message to the second network node comprising either a positive acknowledgement (ACK) or a negative acknowledgment (NACK) of the first indication.

In combination with other embodiments, the first message may inform the first network node of changes, determined by the second network node, related to an ongoing procedure or to a configuration used by the second network node to send measurements and/or predictions to the first network node. The changes indicated by the first message may take effect immediately or at a future a time indicated by the first message, regardless of whether the first network node can accept or not the indicated changes. As such, when the method is applied to a procedure initiated and controlled by the first network node for receiving measurements and/or predictions from the second network node, such as a RESOURCE STATUS REPORTING procedure of the LTE and/or NG-RAN systems, the first network node may acknowledge the correct reception of the modifications.

In one embodiment of the method, the second message comprises a negative acknowledgement of the first indication, and the second message further comprises: a request that the second network node does not resume or continue sending measurements and/or predictions to the first network node. In other words, the second message further comprises a rejection/refuse of the modifications related to the sending of measurements and/or predictions from the second network node indicated in the first message. Additionally, the second message may comprise an instruction for the second network node to not resume or not to continue reporting measurements and/or predictions to the first network node.

In some embodiments, the first message may indicate that the second network node has determined to, is about to, or has paused the sending of measurements and/or predictions to the first network node according to a procedure or configuration previously agreed with the first network node. In this case, for example, the first network node may receive the first message as part of a RESOURCE STATUS UPDATE message, comprising an indication, e.g. a Cell Reporting Indicator IE set to “pause request” for one or more reporting objects, e.g. as indicated by the Cell Measurement Result IE. In response to such modification, the first network node may decide not to resume and instead may stop the sending of measurements and/or predictions from the second network node. Thus, the first network node may initialize the Resource Status Reporting Initiation procedure to remove all or some of the corresponding cells from the measurements and/or predictions previously requested from the second network node.

In some embodiments, wherein the first message comprises a request for one or more modifications related to the sending of measurements and/or predictions from the second network node, the first network node may additionally:
determine, based on the first message, a configuration for the second network node comprising one or more modifications related to the sending of measurements and/or predictions from the second network node;
transmit a second message comprising the configuration for the second network node comprising one or more modifications related to the sending of measurements and/or predictions from the second network node.

In this case, the first network node may determine whether to accept, ignore, reject or modify any of the modifications requested by the second network node related to the sending of measurements and/or predictions from the second network node. Thereby, the first network node may subsequently transmit a second message to the second network node indicating one or more modifications and/or a configuration that the second network node can use for further sending measurements and/or predictions to the first network node. In other words, the second message may comprise an indication of which modifications indicated by the first message are accepted by the first network node.

In non-limiting examples of implementation, the second message may be implemented as one of: an XnAP NG-RAN NODE CONFIGURATION UPDATE, an ENB CONFIGURATION UPDATE, an EN-DC CONFIGURATION UPDATE, an GNB-DU CONFIGURATION UPDATE, an GNB-CU CONFIGURATION UPDATE, an XnAP RESOURCE STATUS REQUEST message, an X2AP RESOURCE STATUS REQUEST message, an X2AP EN-DC RESOURCE STATUS REQUEST message, an F1AP RESOURCE STATUS REQUEST message, and an E1AP RESOURCE STATUS REQUEST.

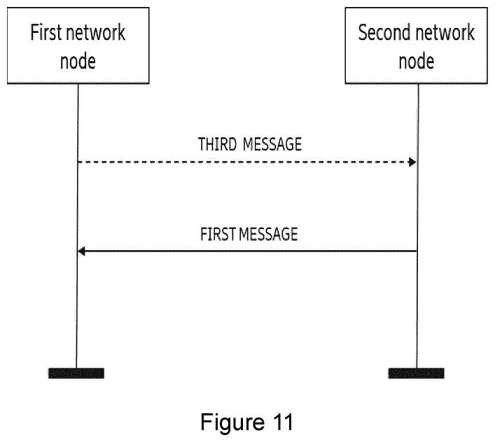

FIG. 11 illustrates a method wherein the second network node receives a third message from the first network node prior to transmitting the first message to the first network node. As previously described, the sending of the first message from the second network node to the first network node may correspond to steps 602 and 702 as described with reference to FIGS. 6 and 7.

In some embodiments, for example as illustrated in FIG. 11, the second network node may send the first message upon receiving a third message from first network node. The third message may comprise least one request of the first network node to the second network node to send measurements and/or predictions to the first network node.

In non-limiting examples of implementation, the third message may be implemented as one of: an XnAP RESOURCE STATUS REQUEST message, as an X2AP RESOURCE STATUS REQUEST message, as an X2AP EN-DC RESOURCE STATUS REQUEST message, an F1AP RESOURCE STATUS REQUEST message, and an E1AP RESOURCE STATUS REQUEST.

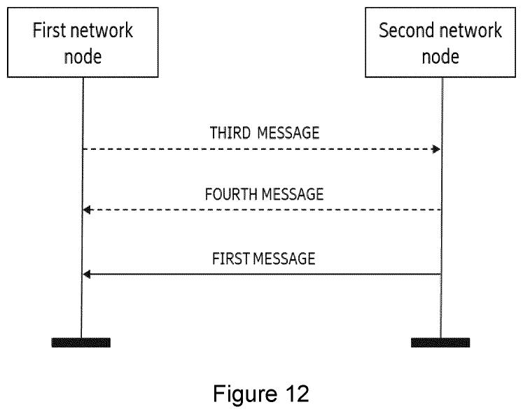

FIG. 12 illustrates a method wherein the second network node further transmits a fourth message to the first network node responsive to the third message to acknowledge or to refuse at least one of the requests comprised in the third message. As previously described, the sending of the first message from the second network node to the first network node may correspond to steps 602 and 702 as described with reference to FIGS. 6 and 7.

In one embodiment, for example as illustrated in FIG. 12, the second network node may send to the first network node a fourth message, responsive to receiving the third message, to acknowledge or to refuse at least one of the requests comprised in the third message.

In non-limiting examples of implementation, the fourth MESSAGE may be implemented as one of:
an XnAP RESOURCE STATUS RESPONSE message, an X2AP RESOURCE STATUS RESPONSE message, an X2AP EN-DC RESOURCE STATUS RESPONSE message, or an E1AP RESOURCE STATUS RESPONSE message, and an F1AP RESOURCE STATUS RESPONSE message
   or
an XnAP RESOURCE STATUS FAILURE message, an X2AP RESOURCE STATUS FAILURE message, an X2AP EN-DC RESOURCE STATUS FAILURE message, an F1AP RESOURCE STATUS FAILURE message, and an E1AP RESOURCE STATUS FAILURE message.

### Examples of Implementation—NR

Some examples of implementation are provided for XnAP (TS 38.423), where the underlined text relates new aspects introduced by the embodiments described herein.

In one example of possible implementation for NR, a new Information Element may be comprised in the XnAP RESOURCE STATUS UPDATE message to indicate whether measurements for a given cell of the second network node are paused or resumed. A possible procedural text indicating the behavior of the second network node can be the following, where the second network node is NG-RAN node1.

Note that in the procedural text and in the following tables, the new Information Element is called Cell Reporting Indicator, which is an existing name of an IE defined in X2AP for E-UTRAN, but used for a different purpose:

“If the NG-RAN node₁ receives the RESOURCE STATUS UPDATE message, which includes the Cell Reporting Indicator IE set to “measurement pause” in one or more items of the Cell Measurement Result IE, the NG-RAN node₁ should assume that no more measurements will be received for the corresponding cells affected, until NG-RAN node; receives the RESOURCE STATUS UPDATE message, which includes the Cell Reporting Indicator IE set to “measurement resume” for the same items of the Cell Measurement Result IE”

### First Example of Implementation—Measurements Paused or Resumed Per Cell

### “9.1.3.21 Resource Status Update

This message is sent by NG-RAN node₂ to NG-RAN node to report the results of the requested measurements.

Direction: NG-RAN node₂ ® NG-RAN node₁.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | ignore |
| NG-RAN node1 | M | | INTEGER | Allocated by | YES | reject |
| Measurement ID | | | (1 . . . 4095, . . . ) | NG-RAN node₁ | | |
| NG-RAN node2 | M | | INTEGER | Allocated by | YES | reject |
| Measurement ID | | | (1 . . . 4095, . . . ) | NG-RAN node₂ | | |
| Cell Measurement | | 1 | | | YES | ignore |
| Result | | | | | | |
| >Cell Measurement | | 1 . . . | | | YES | ignore |
| Result Item | | <maxnoofCellsinNG- | | | | |
| | | RANnode> | | | | |
| >>Cell ID | M | | Global NG-RAN | | — | |
| | | | Cell Identity | | | |
| | | | 9.2.2.27 | | | |
| >>Radio Resource | O | | 9.2.2.50 | | — | |
| Status | | | | | | |
| >>TNL Capacity | O | | 9.2.2.49 | | — | |
| Indicator | | | | | | |
| >>Composite | O | | 9.2.2.51 | | — | |
| Available Capacity | | | | | | |
| Group | | | | | | |
| >>Slice Available | O | | 9.2.2.55 | | — | |
| Capacity | | | | | | |
| >>Number of Active | O | | 9.2.2.62 | | — | |
| UEs | | | | | | |
| >>RRC Connections | O | | 9.2.2.56 | | — | |
| >>Cell Reporting | O | | ENUMERATED | Indicates to | YES | Ignore |
| Indicator | | | (measurement | NG-RAN node₁ | | |
| | | | pause, | whether | | |
| | | | measurement | reporting of cell | | |
| | | | resume . . . ) | measurements | | |
| | | | | for a cell from | | |
| | | | | NG-RAN node₂ | | |
| | | | | is paused or | | |
| | | | | resumed | | |
| >>Cause Value | C- | | 9.2.3.2 | | YES | Ignore |
| | ifCellReportingIndicatorPause | | | | | |

| Condition | Explanation |
|---|---|
| ifCellReportingIndicatorPause | This IE shall be present if the Cell Reporting Indicator IE is set to the value “measurement pause”. |

### Second Example of Implementation—Measurements Paused or Resumed for all Cells

### “9.1.3.21 Resource Status Update

This message is sent by NG-RAN node₂ to NG-RAN node₁ to report the results of the requested measurements.

Direction: NG-RAN node₂ ® NG-RAN node₁.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | ignore |
| NG-RAN node1 | M | | INTEGER | Allocated by | YES | reject |
| Measurement ID | | | (1 . . . 4095, . . . ) | NG-RAN node₁ | | |
| NG-RAN node2 | M | | INTEGER | Allocated by | YES | reject |
| Measurement ID | | | (1 . . . 4095, . . . ) | NG-RAN node₂ | | |
| Cell Measurement | | 1 | | | YES | ignore |
| Result | | | | | | |
| >Cell Measurement | | 1 . . . | | | YES | ignore |
| Result Item | | <maxnoofCellsinNG- | | | | |
| | | RANnode> | | | | |
| >>Cell ID | M | | Global NG-RAN | | — | |
| | | | Cell Identity | | | |
| | | | 9.2.2.27 | | | |
| >>Radio Resource | O | | 9.2.2.50 | | — | |
| Status | | | | | | |
| >>TNL Capacity | O | | 9.2.2.49 | | — | |
| Indicator | | | | | | |
| >>Composite | O | | 9.2.2.51 | | — | |
| Available Capacity | | | | | | |
| Group | | | | | | |
| >>Slice Available | O | | 9.2.2.55 | | — | |
| Capacity | | | | | | |
| >>Number of Active | O | | 9.2.2.62 | | — | |
| UEs | | | | | | |
| >>RRC Connections | O | | 9.2.2.56 | | — | |
| Reporting Indicator | O | | ENUMERATED | Indicates to | YES | Ignore |
| | | | (measurement | NG-RAN node₁ | | |
| | | | pause, | whether | | |
| | | | measurement | reporting of all | | |
| | | | resume . . . ) | measurements | | |
| | | | | from NG-RAN | | |
| | | | | node₂ is paused | | |
| | | | | or resumed | | |
| Cause Value | C- | | 9.2.3.2 | | YES | Ignore |
| | ifReportingIndicatorPause | | | | | |

| Condition | Explanation |
|---|---|
| ifReportingIndicatorPause | This IE shall be present if the Reporting Indicator IE is set to the value “measurement pause”. |

### Third Example of Implementation—Measurements Paused or Resumed Per Measurement

In this example, the indication to pause or resume a measurement has been added to the Slice Available Capacity IE for simplicity. However, the same indication may be added to each cell measurement result reported by NG-RAN Node 2

### “9.1.3.21 Resource Status Update

This message is sent by NG-RAN node₂ to NG-RAN node₁ to report the results of the requested measurements.

Direction: NG-RAN node₂ ® NG-RAN node₁.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | ignore |
| NG-RAN node1 | M | | INTEGER | Allocated by | YES | reject |
| Measurement ID | | | (1 . . . 4095, . . . ) | NG-RAN node₁ | | |
| NG-RAN node2 | M | | INTEGER | Allocated by | YES | reject |
| Measurement ID | | | (1 . . . 4095, . . . ) | NG-RAN node₂ | | |
| Cell Measurement | | 1 | | | YES | ignore |
| Result | | | | | | |
| >Cell Measurement | | 1 . . . | | | YES | ignore |
| Result Item | | <maxnoofCellsinNG- | | | | |
| | | RANnode > | | | | |
| >>Cell ID | M | | Global NG-RAN | | — | |
| | | | Cell Identity | | | |
| | | | 9.2.2.27 | | | |
| >>Radio Resource | O | | 9.2.2.50 | | — | |
| Status | | | | | | |
| >>TNL Capacity | O | | 9.2.2.49 | | — | |
| Indicator | | | | | | |
| >>Composite | O | | 9.2.2.51 | | — | |
| Available Capacity | | | | | | |
| Group | | | | | | |
| >>Slice Available | O | | 9.2.2.55 | | — | |
| Capacity | | | | | | |
| >>Number of Active | O | | 9.2.2.62 | | — | |
| UEs | | | | | | |
| >>RRC Connections | O | | 9.2.2.56 | | — | |

### 9.2.2.55 Slice Available Capacity

The Slice Available Capacity IE indicates the amount of resources per network slice that are available per cell relative to the total NG-RAN resources per cell. The Slice Capacity Value Downlink IE and the Slice Capacity Value Uplink IE can be weighted according to the ratio of the corresponding cell capacity class values contained in the Composite Available Capacity Group IE, if available.

| | | | IE type and | |
|---|---|---|---|---|
| IE/Group Name | Presence | Range | reference | Semantics description |
| Slice Available | | 1 . . . | | |
| Capacity | | <maxnoofBPLMNs> | | |
| >PLMN Identity | M | | 9.2.2.4 | Broadcast PLMN |
| >S-NSSAI Available | | 1 | | |
| Capacity List | | | | |
| >>S-NSSAI Available | M | 1 . . . | | |
| Capacity Item | | <maxnoofSliceItems> | | |
| >>>S-NSSAI | | | 9.2.3.21 | |
| >>>Slice Available | O | | INTEGER | Value 0 indicates no available capacity, |
| Capacity Value | | | (0 . . . 100) | and 100 indicates maximum available |
| Downlink | | | | capacity. Slice Capacity Value should be |
| | | | | measured on a linear scale. |
| >>>Slice Available | O | | INTEGER | Value 0 indicates no available capacity, |
| Capacity Value | | | (0 . . . 100) | and 100 indicates maximum available |
| Uplink | | | | capacity. Slice Capacity Value should be |
| | | | | measured on a linear scale. |
| >>> Reporting | O | | ENUMERATED | Indicates to NG-RAN node₁ |
| Indicator | | | (measurement pause, | whether reporting of measurements from |
| | | | measurement | NG-RAN node₂ is paused |
| | | | resume . . .) | or resumed for the S-NSSAI |
| >>> Cause | C-ifReportingIndi- | | 9.2.3.2 | |
| Value | catorPause | | | |

| Condition | Explanation |
|---|---|
| ifReportingIndicatorPause | This IE shall be present if the Reporting |
| | Indicator IE is set to the value |
| | “measurement pause”. |

### Examples of Implementation—E-UTRAN

One example of implementation is provided for X2AP (TS 36.423), where the underlined text relates to the present invention. A cause value is added to indicate to eNB1 the reason for which eNB2 sent a “stop request”.

### 9.1.2.14 Resource Status Update

This message is sent by eNB₂ to neighbouring eNB₁ to report the results of the requested measurements.

Direction: eNB₂ ® eNB₁.

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | ignore |
| eNB1 Measurement ID | M | | INTEGER | Allocated by | YES | reject |
| | | | (1 . . . 4095, . . . ) | eNB₁ | | |
| eNB2 Measurement ID | M | | INTEGER | Allocated by | YES | reject |
| | | | (1 . . . 4095, . . . ) | eNB₂ | | |
| Cell Measurement Result | | 1 | | | YES | ignore |
| >Cell Measurement | | 1 . . . | | | EACH | ignore |
| Result Item | | <maxCellineNB> | | | | |
| >>Cell ID | M | | ECGI | | | |
| | | | 9.2.14 | | | |
| >>Hardware Load | O | | 9.2.34 | | | |
| Indicator | | | | | | |
| >>S1 TNL Load | O | | 9.2.35 | | | |
| Indicator | | | | | | |
| >>Radio Resource | O | | 9.2.37 | | | |
| Status | | | | | | |
| >>Composite Available | O | | 9.2.44 | | YES | ignore |
| Capacity Group | | | | | | |
| >>ABS Status | O | | 9.2.58 | | YES | ignore |
| >>RSRP Measurement | O | | 9.2.76 | | YES | ignore |
| Report List | | | | | | |
| >>CSI Report | O | | 9.2.79 | | YES | ignore |
| >>Cell Reporting | O | | ENUMERATED | | YES | Ignore |
| Indicator | | | (stop | | | |
| | | | request, . . . ) | | | |
| >>Cause Value | O | | 9.2.3.2 | | | |

| Range bound | Explanation |
|---|---|
| maxCellineNB | Maximum no. cells that can be served by an eNB. Value is 256. |

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3rd Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 13, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, a content source and analytics node, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

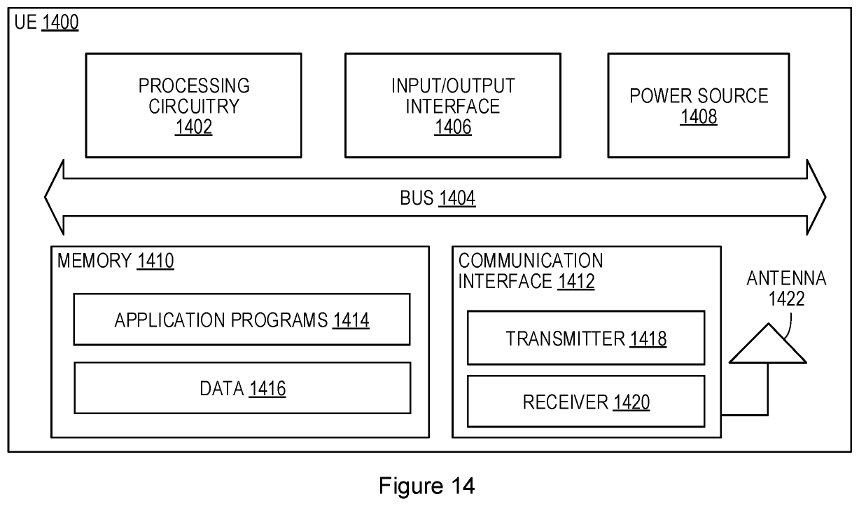

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs). The processing circuitry 1402 may be operable to provide, either alone or in conjunction with other UE 1400 components, such as the memory 1410, UE 1400 functionality.

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In some embodiments, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes processing circuitry 1502, a memory 1504, a communication interface 1506, and a power source 1508, and/or any other component, or any combination thereof. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, network node 1500 functionality. For example, the processing circuitry 1502 may be configured to cause the network node to perform the methods as described with reference to FIG. 6 or 7.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

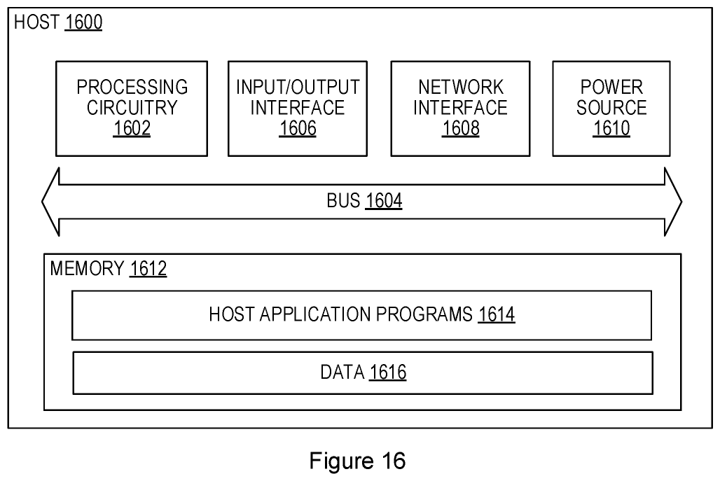

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

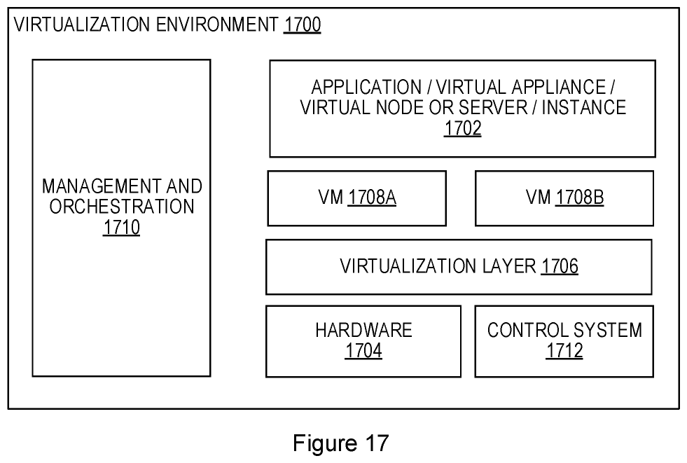

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

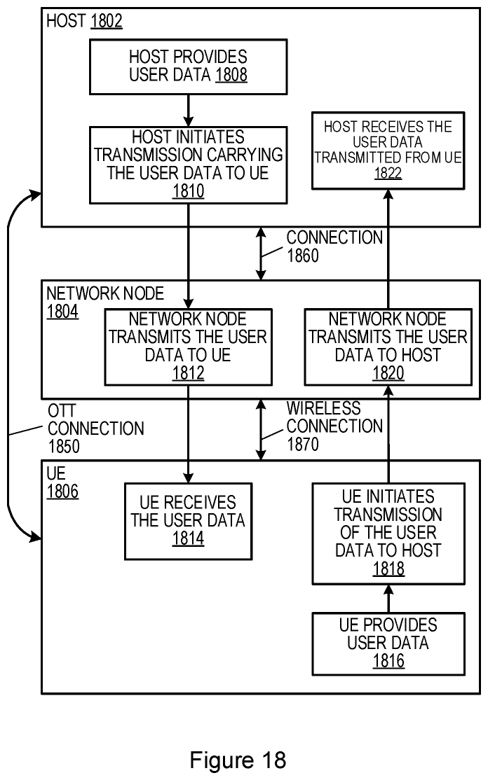

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment. More precisely, the teachings of these embodiments may improve the signaling overhead and thereby provide benefits such as reduced power requirements.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

At least some of the following abbreviations may be used in this disclosure. If there is an inconsistency between abbreviations, preference should be given to how it is used above. If listed multiple times below, the first listing should be preferred over any subsequent listing(s).
3GPP 3rd Generation Partnership Project
5GCN 5G Core Network
5GS 5G System
AF Application Function
AMF Access and Mobility Management Function
AN Access Network
CN Core Network
CP Control Plane
CU Central Unit
DC Dual Connectivity
DU Distributed Unit
eNB E-UTRAN NodeB
EN-DC E-UTRA-NR Dual Connectivity
E-UTRA Evolved UTRA
E-UTRAN Evolved UTRAN
gNB Radio base station in NR
ID Identifier/Identity
IE Information Element
LTE Long Term Evolution
MME Mobility Management Entity
MN Master Node
MR-DC Multi-Radio Dual Connectivity
NE-DC NR-E-UTRA Dual Connectivity
NEF Network Exposure Function
NG Next Generation
NGEN-DC NG-RAN E-UTRA-NR Dual Connectivity
NG-RAN NG Radio Access Network
NR New Radio
OAM/O&M Operation and Maintenance
QOS Quality of Service
RAN Radio Access Network
RAT Radio Access Technology
RRC Radio Resource Control
S1 The interface between the RAN and the CN in LTE.
S1AP S1 Application Protocol
SMF Session Management Function
SMO Service Management and Orchestration
SN Secondary Node
UE User Equipment
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCE Control Channel Element
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GBR Guaranteed Bit Rate
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
NR-U NR Unlicensed
O-CU O-RAN Central Unit
O-CU-CP O-RAN Central Unit-Control Plane
O-CU-UP O-RAN Central Unit-User Plane
O-DU O-RAN Distributed Unit
O-RU O-RAN Radio Unit
O-eNB O-RAN eNB
O-RAN Open RAN
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRB Physical Resource Block
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TNL Transport Network Layer
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

The following are certain enumerated embodiments further illustrating various aspects the disclosed subject matter.

### Group B Embodiments

1. A method performed by a first network node in communication with a second network node, wherein the second network node has been requested or is being requested to send measurements and/or predictions available at the second network node to the first network node, the method comprising:
receiving, from the second network node, a first message comprising a first indication that sending of measurements and/or predictions from the second network node to the first network node is to be paused, delayed, resumed, or stopped.

2. The method of embodiment 1, wherein the first message further comprises a reason for pausing, delaying, resuming or stopping the sending of measurements and/or predictions from the second network node to the first network node.

3. The method of any of embodiments 1 or 2 wherein the first message further comprises a second indication of one or more measurements and/or predictions to which the first indication applies.

4. The method of any one of embodiments 1 to 3 wherein the first message further comprises a third indication of one or more reporting objects associated with one or more measurements and/or predictions to which the first indication applies.

5. The method of embodiment 4 wherein the one or more reporting objects comprise one or more of: a network node, one or more cells, one or more SSB Indexes, one or more SSB Areas, one or more S-NSSAIs or Slices, one or more CSI-RS coverage areas, one or more Tracking Areas/Tracking Area Lists/PLMNs.

6. The method of any one of embodiments 1 to 5, wherein the first message further comprises one or more of: a start time at which the first indication applies; an end time at which the first indication will no longer apply; and a duration for which the first indication will apply.

7. The method of embodiment 6 wherein the duration is expressed as a number of reporting periods.

8. The method of any one of embodiments 1 to 7 wherein the second network node is previously configured to transmit the measurements and/or predictions at a first reporting periodicity, and the first indication comprises a second reporting periodicity that the first network node is to use.

9. The method of embodiment 8 further comprising:
determining a third reporting periodicity, wherein the third reporting periodicity comprises periods that are equal to or longer than the periods of the second reporting periodicity, and
initiating a request for measurements and/or predictions from the second network node, wherein the request is for measurements and/or predictions to be provided at the third reporting periodicity.

10. The method of any previous embodiment wherein the first message comprises one or more first measurements and/or predictions.

11. The method of embodiment 10 wherein the first message comprises an indication of whether the one or more first measurements and/or predictions in the first message are delayed.

12. The method of any previous embodiment wherein the first message is signaled via one of XnAP, X2AP, E1AP, F1AP, W1AP and comprises one of: an XnAP resource state update message, an X2AP resource status update message, an X2AP EN-DC resource status update message, an F1AP resource status update message, and an E1AP resource status update message.

13. The method of any previous embodiment wherein the first network node and the second network node are either: comprised within the same communication system or comprised within different communication systems.

14. The method of any previous embodiment wherein the first message is received over a direct signaling connection between the first network node and the second network node.

15. The method of any previous embodiment wherein the first message is received over an indirect signaling connection between the first network node and the second network node.

16. The method of any embodiment 15 wherein the first message is received via one or more third network node.

17. The method of embodiment 16 wherein a third network node comprises one of: a radio access network node, a core network node, an Operations, administration and management (OAM) node and a Service Management and Orchestration (SMO) node.

18. The method of any previous embodiment wherein the first network node, the second network node and a third network node each comprise one of: a RAN node, a gNB, eNB, en-gNB, ng-eNB, gNB-CU, gNB-CU-CP, gNB-CU-UP, gNB-DU, eNB-CU, eNB-CU-CP, eNB-CU-UP, eNB-DU, IAB-nodes, IAB-donors, IAB-donor-CU, IAB-donor-CU-CP, IAB-donor-CU-UP, IAB-donor-DU, IAB-MT, O-CU, O-CU-CP, O-CU-UP, O-DU, O-RU, O-eNB.

19. The method of embodiment 18 wherein the first network node and the second network node comprise two functions of a radio access node in a distributed architecture.

20. The method of any previous embodiment further comprising:
responsive to receiving the first message, waiting to receive a second message comprising an indication that sending of measurements and/or predictions from the second network node to the first network node is to be resumed.

21. The method of any previous embodiment further comprising:
responsive to receiving the first indication indicating that sending of measurements and/or predictions from the second network node to the first network node is to be delayed, accepting or discarding X, where X is an integer value, delayed measurements and/or predictions.

22. The method of any one of embodiments 1 to 21 further comprising:
responsive to the first indication indicating that sending of measurements and/or predictions from the second network node to the first network node is to be delayed, performing one of:
ignoring delayed measurements and/or predictions; and starting a timer and only accepting delayed measurements and/or predictions if they are received before the timer expires.

23. The method of any previous embodiment further comprising:
responsive to receiving first message, transmitting a second message to the second network node comprising either a positive acknowledgement or a negative acknowledgement of the first indication.

24. The method of embodiment 23 wherein the second message comprises a negative acknowledgement of the first indication, and the second message further comprises:
a request that the second network node does not resume or continue sending measurements and/or predictions to the first network node.

25. The method of embodiment 23 wherein the second message comprises an indication of which modifications indicated by the first message are accepted by the first network node.

26. The method of any one of embodiments 23 to 25 wherein the second message comprises one of: an XnAP NG-RAN NODE CONFIGURATION UPDATE, an ENB CONFIGURATION UPDATE, an EN-DC CONFIGURATION UPDATE, a GNB-DU CONFIGURATION UPDATE, a GNB-CU CONFIGURATION UPDATE, an XnAP RESOURCE STATUS REQUEST message, an X2AP RESOURCE STATUS REQUEST message, an X2AP EN-DC RESOURCE STATUS REQUEST message, an F1AP RESOURCE STATUS REQUEST message, an E1AP RESOURCE STATUS REQUEST.

27. The method as in any previous embodiment further comprising receiving the first message responsive to transmitting a third message to the second network node, wherein the third message comprises a request that the second network node send measurements and/or predictions to the first network node.

28. The method as in embodiment 27 wherein the third message comprises one of: an XnAP RESOURCE STATUS REQUEST message, an X2AP RESOURCE STATUS REQUEST message, an X2AP EN-DC RESOURCE STATUS REQUEST message, an F1AP RESOURCE STATUS REQUEST message, and an E1AP RESOURCE STATUS REQUEST.

29. The method as in embodiment 27 or 28 further comprising receiving a fourth message in response to transmitting the third message to the second network node, wherein the fourth message acknowledges or refuses the request of the third message.

30. The method as in embodiment 29 wherein the fourth message comprises one of: an XnAP RESOURCE STATUS RESPONSE message, an X2AP RESOURCE STATUS RESPONSE message, an X2AP EN-DC RESOURCE STATUS RESPONSE message, an E1AP RESOURCE STATUS RESPONSE message, an F1AP RESOURCE STATUS RESPONSE message, an XnAP RESOURCE STATUS FAILURE message, an X2AP RESOURCE STATUS FAILURE message, an X2AP EN-DC RESOURCE STATUS FAILURE message, an F1AP RESOURCE STATUS FAILURE message, and an E1AP RESOURCE STATUS FAILURE message.

31. A method performed by a second network node in communication with a first network node, wherein the second network node has been requested or is being requested to send measurements and/or predictions available at the second network node to the first network node, the method comprising:
transmitting, to the first network node, a first message comprising a first indication that sending of measurements and/or predictions from the second network node to the first network node is to be paused, delayed, resumed, or stopped.

32. The method of embodiment 31 wherein the first message further comprises a reason for pausing, delaying, resuming or stopping the sending of measurements and/or predictions from the second network node to the first network node.

33. The method of any one of embodiments 31 to 32, wherein the first message further comprises: a second indication of one or more measurements and/or predictions to which the first indication applies.

34. The method of any one of embodiments 31 to 33, wherein the first message further comprises a third indication of one or more reporting objects associated with one or more measurements and/or predictions to which the first indication applies.

35. The method of embodiment 34 wherein the one or more reporting objects comprise one or more of: a network node, one or more cells, one or more SSB Indexes, one or more SSB Areas, one or more S-NSSAIs or Slices, one or more CSI-RS coverage areas, one or more Tracking Areas/Tracking Area Lists/PLMNs.

36. The method of any one of embodiments 31 to 35, wherein the first message further comprises one or more of: a start time at which the first indication applies; an end time at which the first indication will no longer apply; and a duration for which the first indication will apply.

37. The method of embodiment 36 wherein the duration is expressed as a number of reporting periods.

38. The method of any one of embodiments 31 to 37 wherein the second network node is previously configured to transmit the measurements and/or predictions at a first reporting periodicity, and wherein the first indication comprises a second reporting periodicity for the first network node to use.

39. The method of any one of embodiments 31 to 38 wherein the first message comprises one or more first measurements and/or predictions.

40. The method of embodiment 39 wherein the first message comprises an indication of whether the one or more first measurements and/or predictions in the first message are delayed.

41. The method of any one of embodiments 31 to 40 wherein the first message is signaled via one of XnAP, X2AP, E1AP, F1AP, W1AP and comprises one of: an XnAP resource state update message, an X2AP resource status update message, an X2AP EN-DC resource status update message, an F1AP resource status update message, and an E1AP resource status update message.

42. The method of any one of embodiments 31 to 41 wherein the first network node and the second network node are either: comprised within the same communication system; or comprised within different communication systems.

43. The method of any one of embodiments 31 to 42 wherein the first message is transmitted over a direct signaling connection between the first network node and the second network node.

44. The method of any one of embodiments 31 to 42 wherein the first message is transmitted over an indirect signaling connection between the first network node and the second network node.

45. The method of any embodiment 44 wherein the first message is transmitted via one or more third network node.

46. The method of embodiment 45 wherein a third network node comprises one of: a radio access network node, a core network node, an OAM node and an SMO node.

47. The method of any one of embodiments 31 to 46 wherein the first network node, the second network node and a third network node each comprise one of: a RAN node, a gNB, eNB, en-gNB, ng-eNB, gNB-CU, gNB-CU-CP, gNB-CU-UP, gNB-DU, eNB-CU, eNB-CU-CP, eNB-CU-UP, eNB-DU, IAB-nodes, IAB-donors, IAB-donor-CU, IAB-donor-CU-CP, IAB-donor-CU-UP, IAB-donor-DU, IAB-MT, O-CU, O-CU-CP, O-CU-UP, O-DU, O-RU, O-eNB.

48. The method of embodiment 47 wherein the first network node and the second network node comprise two functions of a radio access node in a distributed architecture.

49. The method of any one of embodiments 31 to 48 further comprising:
responsive to the first indication indicating that the sending of measurements and/or predictions from the second network node to the first network node is to be stopped paused or delayed, transmitting a second message to the first network node comprising an indication that sending of measurements and/or predictions from the second network node to the first network node is to be resumed.

50. The method of any one of embodiments 31 to 49 further comprising:
responsive to transmitting the first message, receiving a second message from the first network node comprising either a positive acknowledgement or a negative acknowledgement of the first indication.

51. The method of embodiment 50 wherein the second message comprises a negative acknowledgement of the first indication, and the second message further comprises:
a request that the second network node does not resume or continue sending measurements and/or predictions to the first network node.

52. The method of embodiment 50 wherein the second message comprises an indication of which modifications indicated by the first message are accepted by the first network node.

53. The method of any one of embodiments 50 to 52 wherein the second message comprises one of: an XnAP NG-RAN NODE CONFIGURATION UPDATE, an ENB CONFIGURATION UPDATE, an EN-DC CONFIGURATION UPDATE, a GNB-DU CONFIGURATION UPDATE, a GNB-CU CONFIGURATION UPDATE, an XnAP RESOURCE STATUS REQUEST message, an X2AP RESOURCE STATUS REQUEST message, an X2AP EN-DC RESOURCE STATUS REQUEST message, an F1AP RESOURCE STATUS REQUEST message, an E1AP RESOURCE STATUS REQUEST.

54. The method as in any one of embodiments 31 to 53 further comprising transmitting the first message responsive to receiving a third message from the first network node, wherein the third message comprises a request that the second network node send measurements and/or predictions to the first network node.

55. The method as in embodiment 54 wherein the third message comprises one of: an XnAP RESOURCE STATUS REQUEST message, an X2AP RESOURCE STATUS REQUEST message, an X2AP EN-DC RESOURCE STATUS REQUEST message, an F1AP RESOURCE STATUS REQUEST message, and an E1AP RESOURCE STATUS REQUEST.

56. The method as in embodiment 54 or 55 further comprising transmitting a fourth message to the first network node in response to receiving the third message, wherein the fourth message acknowledges or refuses the request of the third message.

57. The method as in embodiment 56 wherein the fourth message comprises one of: an XnAP RESOURCE STATUS RESPONSE message, an X2AP RESOURCE STATUS RESPONSE message, an X2AP EN-DC RESOURCE STATUS RESPONSE message, an E1AP RESOURCE STATUS RESPONSE message, an F1AP RESOURCE STATUS RESPONSE message. an XnAP RESOURCE STATUS FAILURE message, an X2AP RESOURCE STATUS FAILURE message, an X2AP EN-DC RESOURCE STATUS FAILURE message, an F1AP RESOURCE STATUS FAILURE message, and an E1AP RESOURCE STATUS FAILURE message.

### Group C Embodiments

58. A network node, the network node comprising:
processing circuitry configured to cause the network node to perform any of the steps of any of the Group B embodiments;
power supply circuitry configured to supply power to the processing circuitry.

59. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

60. The host of the previous embodiment, wherein:
the processing circuitry of the host is configured to execute a host application that provides the user data; and
the UE comprises processing circuitry configured to execute a client application associated with the host application to receive the transmission of user data from the host.

61. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

62. The method of the previous embodiment, further comprising, at the network node, transmitting the user data provided by the host for the UE.

63. The method of any of the previous 2 embodiments, wherein the user data is provided at the host by executing a host application that interacts with a client application executing on the UE, the client application being associated with the host application.

64. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

65. The communication system of the previous embodiment, further comprising:
the network node; and/or the user equipment.

66. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

67. The host of the previous 2 embodiments, wherein:
the processing circuitry of the host is configured to execute a host application, thereby providing the user data; and
the host application is configured to interact with a client application executing on the UE, the client application being associated with the host application.

68. The host of the any of the previous 2 embodiments, wherein the initiating receipt of the user data comprises requesting the user data.

69. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

70. The method of the previous embodiment, further comprising at the network node, transmitting the received user data to the host.

1. A method performed by a first network node in communication with a second network node, wherein the second network node has been requested or is being requested to send measurements and/or predictions available at the second network node to the first network node, the method comprising:
receiving, from the second network node, a first message comprising a first indication that sending of measurements and/or predictions from the second network node to the first network node is to be paused, delayed, resumed, or stopped.

2. The method of claim 1, wherein the first message further comprises a reason for pausing, delaying, resuming or stopping the sending of measurements and/or predictions from the second network node to the first network node.

3. The method of claim 1, wherein the first message further comprises a second indication of one or more measurements and/or predictions to which the first indication applies.

4. The method of claim 1, wherein the first message further comprises a third indication of one or more reporting objects associated with one or more measurements and/or predictions to which the first indication applies.

5. The method of claim 4 wherein the one or more reporting objects comprise one or more of: a network node, one or more cells, one or more SSB Indexes, one or more SSB Areas, one or more S-NSSAIs or Slices, one or more/CSI-RS coverage areas, one or more Tracking Areas/Tracking Area Lists/PLMNs.

6. The method of claim 1, wherein the first message comprises one or more first measurements and/or predictions.

7. The method of claim 1, wherein the first message is signaled via one of XnAP, X2AP, E1AP, F1AP, W1AP and comprises one of: an XnAP resource state update message, an X2AP resource status update message, an X2AP EN-DC resource status update message, an F1AP resource status update message, and an E1AP resource status update message.

8. The method of claim 1, wherein the first network node and the second network node are either: comprised within the same communication system or comprised within different communication systems.

9. The method of claim 1, wherein the first message is received over one of a direct signaling connection between the first network node and the second network node or an indirect signaling connection between the first network node and the second network node.

10. The method of claim 1, wherein the first network node, the second network node and a third network node each comprise one of: a RAN node, a gNB, eNB, en-gNB, ng-eNB, gNB-CU, gNB-CU-CP, gNB-CU-UP, gNB-DU, eNB-CU, eNB-CU-CP, eNB-CU-UP, eNB-DU, IAB-nodes, IAB-donors, IAB-donor-CU, IAB-donor-CU-CP, IAB-donor-CU-UP, IAB-donor-DU, IAB-MT, O-CU, O-CU-CP, O-CU-UP, O-DU, O-RU, O-eNB.

11. The method of claim 10 wherein the first network node and the second network node comprise two functions of a radio access node in a distributed architecture.

12. The method of claim 1, further comprising:
responsive to receiving the first message, waiting to receive a second message comprising an indication that sending of measurements and/or predictions from the second network node to the first network node is to be resumed.

13. The method as in claim 1, further comprising receiving the first message responsive to transmitting a third message to the second network node, wherein the third message comprises a request that the second network node send measurements and/or predictions to the first network node.

14. The method as in claim 13 further comprising receiving a fourth message in response to transmitting the third message to the second network node, wherein the fourth message acknowledges or refuses the request of the third message.

15. A method performed by a second network node in communication with a first network node, wherein the second network node has been requested or is being requested to send measurements and/or predictions available at the second network node to the first network node, the method comprising:
transmitting, to the first network node, a first message comprising a first indication that sending of measurements and/or predictions from the second network node to the first network node is to be paused, delayed, resumed, or stopped.

16. The method of claim 15 wherein the first message further comprises a reason for pausing, delaying, resuming or stopping the sending of measurements and/or predictions from the second network node to the first network node.

17. The method of claim 15, wherein the first message further comprises: a second indication of one or more measurements and/or predictions to which the first indication applies.

18. The method of claim 15, wherein the first message further comprises a third indication of one or more reporting objects associated with one or more measurements and/or predictions to which the first indication applies.

19. The method of claim 18 wherein the one or more reporting objects comprise one or more of: a network node, one or more cells, one or more SSB Indexes, one or more SSB Areas, one or more S-NSSAIs or Slices, one or more CSI-RS coverage areas, one or more Tracking Areas/Tracking Area Lists/PLMNs.

20. The method of claim 15, wherein the first message comprises one or more first measurements and/or predictions.

21. The method of claim 15, wherein the first message is signaled via one of XnAP, X2AP, E1AP, F1AP, WAP and comprises one of: an XnAP resource state update message, an X2AP resource status update message, an X2AP EN-DC resource status update message, an F1AP resource status update message, and an E1AP resource status update message.

22. The method of claim 15, wherein the first network node and the second network node are either: comprised within the same communication system; or comprised within different communication systems.

23. The method of claim 15, wherein the first message is transmitted over one of a direct signaling connection between the first network node and the second network node or an indirect signaling connection between the first network node and the second network node.

24. The method of claim 15, wherein the first network node, the second network node and a third network node each comprise one of: a RAN node, a gNB, eNB, en-gNB, ng-eNB, gNB-CU, gNB-CU-CP, gNB-CU-UP, gNB-DU, eNB-CU, eNB-CU-CP, eNB-CU-UP, eNB-DU, IAB-nodes, IAB-donors, IAB-donor-CU, IAB-donor-CU-CP, IAB-donor-CU-UP, IAB-donor-DU, IAB-MT, O-CU, O-CU-CP, O-CU-UP, O-DU, O-RU, O-eNB.

25. The method of claim 24 wherein the first network node and the second network node comprise two functions of a radio access node in a distributed architecture.

26-28. (canceled)

29. A second network node in communication with a first network node, wherein the second network node has been requested or is being requested to send measurements and/or predictions available at the second network node to the first network node, the second network node comprising:
processing circuitry configured to transmit, to the first network node, a first message comprising a first indication that sending of measurements and/or predictions from the second network node to the first network node is to be paused, delayed, resumed, or stopped; and
power supply circuitry configured to supply power to the processing circuitry.
